(19) United States
(12) Patent Application Publication
(10) Pub. No.: US 2015/0050835 A1
(43) Pub. Date: Feb. 19, 2015

(54) ELECTRICAL CONNECTOR AND ELECTRICAL CONNECTOR SERIES

(71) Applicant: Lotes Co., Ltd., Keelung (TW)

(72) Inventor: Ted Ju, Keelung (TW)

(73) Assignee: Lotes Co., Ltd., Keelung (TW)

(21) Appl. No.: 14/109,559

(22) Filed: Dec. 17, 2013

(30) Foreign Application Priority Data
Aug. 14, 2013 (CN) 201320495474.9

(51) Int. Cl. H01R 13/516

(52) U.S. Cl. CPC H01R 13/516
USPC 439/607.01

(57) ABSTRACT

An electrical connector, belonging to one of electrical connector series of different height specifications, is used for being fixed to a circuit board. The electrical connector includes an insulating body, a plurality of terminals, a shielding case disposed on the insulating body and having at least one fixing pin, and an abutting portion. Each terminal has a base fixed in the insulating body, an elastic portion bent and extending from one end of the base, a contact portion protruding from the elastic portion, and a soldering portion bent and extending from a side edge of the other end of the base. The abutting portion is formed on the soldering portion or the fixing pin by blanking. The abutting portion presses against the circuit board, and a height difference between the insulating body and the circuit board is adjustable by adjusting the height of the abutting portion.

### CROSS-REFERENCE TO RELATED APPLICATION

This non-provisional application claims priority under 35 U.S.C. §119(a) on Patent Application No. 201320495474.9 filed in P.R. China on Aug. 14, 2013, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates generally to an electrical connector and electrical connector series, and more particularly to an audio electrical connector and electrical connector series suitable for various height specifications.

### BACKGROUND OF THE INVENTION

Chinese Patent No. CN200920059867.9 discloses an electrical connector including an insulating body. A circular insertion hole for a mating audio plug to be inserted therein is formed in the center of the insulating body. A plurality of signal terminals is disposed around the insertion hole. The signal terminal has a fixing portion fixed in the insulating body. A contact portion is bent and extending from one end of the fixing portion, and enters the insertion hole to contact the mating audio plug. An abutting portion is bent and extending from the other end of the fixing portion. A soldering portion is bent and extending from an end of the abutting portion. The electrical connector is mounted on a circuit board in a sinking manner, so that the soldering portion is inserted into a hole of the circuit board and at the same time the abutting portion presses against the circuit board, so as to control the depth by which the electrical connector sinks into the circuit board.

Since different users require electrical connectors of different heights, electrical connectors of various height specifications need to be manufactured meeting with the market demand. Here, the height refers to a height difference between the center of the circle of the insertion hole and the circuit board. However, for each electrical connector with certain height, different sets of molds are required to manufacture the corresponding terminals and insulating bodies, which increases the manufacturing cost.

Therefore, a heretofore unaddressed need exists in the art to address the aforementioned deficiencies and inadequacies.

### SUMMARY OF THE INVENTION

In one aspect, the present invention is directed to an electrical connector and electrical connector series applicable to different height specifications.

In one embodiment, an electrical connector, belonging to one of electrical connector series of different height specifications, is used for being fixed to a circuit board. The electrical connector includes an insulating body, a plurality of terminals, a shielding case disposed on the insulating body, and an abutting portion. Each of the terminals has a base fixed in the insulating body, an elastic portion bent and extending from one end of the base, a contact portion protruding from the elastic portion, and a soldering portion bent and extending from a side edge of the other end of the base. The shielding case has at least one fixing pin. The abutting portion is formed on the soldering portion or the fixing pin by blanking. The abutting portion presses against the circuit board. A height difference between the insulating body and the circuit board is adjustable by adjusting the height of the abutting portion.

Further, a side wall of the insulating body has at least one slot for receiving a part of the abutting portion. The length of the slot is greater than the height of the abutting portion.

Further, the soldering portion and the abutting portion are both formed by blanking, and the abutting portion extends laterally downwards from the soldering portion. The downward extension length of the abutting portion is smaller than downward extension length of the soldering portion.

Further, a groove is formed between the soldering portion and the abutting portion.

Further, the insulating body has a plurality of receiving slots. The terminals are disposed in the receiving slots. When the contact portion is pressed, a side surface of the elastic portion urges against an inner wall of the receiving slot.

Further, the soldering portion is bent and extends from a top side edge of the base, and the soldering portion is perpendicular to the base.

Further, the contact portion is bent and extends from an end of the elastic portion, and the width of the contact portion is greater than the width of the elastic portion.

Further, a front end of the contact portion has two guide chamfers, and a contact tip is formed between the two guide chamfers.

Further, the elastic portion is bent and extends upwards from a lower edge of the base, the elastic portion is parallel to the base, an end of the elastic portion is bent and extends to form the contact portion, and the contact portion is located above a middle portion of the base.

Further, an insertion hole is formed in the center of the insulating body. The abutting portion presses against the circuit board at a different height, and a height difference between the center of circle of the insertion hole and the circuit board is also different.

Further, the abutting portion and the fixing pin are both formed by blanking, and when the fixing pin is inserted into the circuit board, the abutting portion presses against a surface of the circuit board.

Further, the terminals are formed by continuous die stamping, the soldering portion is formed by blanking in a blanking die, and the height of the abutting portion is adjusted by replacing a different blanking die.

In another embodiment, an electrical connector series includes a plurality of electrical connectors of different height specifications. Each of the electrical connectors includes an insulating body, a plurality of terminals disposed in the insulating body, and a shielding case covering the insulating body.

Each of the terminals has a base fixed in the insulating body, an elastic portion bent and extending from one end of the base, a contact portion provided on the elastic portion, and a soldering portion bent and extending from a side edge of the other end of the base. Two sides of the shielding case have at least one fixing pin. The fixing pin and/or the soldering portion are formed by blanking. The insulating body, the terminals and the shielding case of each electrical connector are the same as those in other electrical connectors, except that blanking shapes of the soldering portions and/or the fixing pins are different.

Further, the electrical connector is mounted on a circuit board. The soldering portion and/or the fixing pin are provided thereon with an abutting portion. The abutting portion presses against the circuit board. When the soldering portion and/or the fixing pin is formed by blanking, the blanking shapes of the soldering portion and/or the fixing pin can be changed so as to change the height of the abutting portion.

Further, an insertion hole is formed in the center of the insulating body. When the height of the abutting portion is different, a height difference between the insertion hole and the circuit board is also different.

Further, a groove is formed between the soldering portion and the abutting portion.

Further, a side wall of the insulating body has at least one slot for receiving a part of the abutting portion. The length of the slot is greater than the height of the abutting portion.

Further, the elastic portion is bent and extends upwards from a lower edge of the base, the elastic portion is parallel to the base, an end of the elastic portion is bent and extends to form the contact portion, and the contact portion is located above a middle portion of the base.

Further, the soldering portion is bent and extends from a top side edge of the base, and the soldering portion is perpendicular to the base.

Further, the insulating body is provided with a plurality of receiving slots. The terminals are disposed in the receiving slots. When the contact portion is pressed, a side surface of the elastic portion urges against an inner wall of the receiving slot.

Further, the terminals are formed by continuous die stamping, the soldering portion is formed by blanking in a blanking die, and the shape of the soldering portion is adjusted by replacing a different blanking die.

In one aspect, the present invention is directed to an electrical connector for being fixed to a circuit board.

In one embodiment, an electrical connector for being fixed to a circuit board includes an insulating body, a plurality of terminals, a shielding case, and an abutting portion. Each of the plurality of terminals has a base fixed in the insulating body, an elastic portion bent and extending from one end of the base, a contact portion protruding from the elastic portion, and a soldering portion bent and extending from a side edge of the other end of the base. The shielding case is disposed on the insulating body, and has at least one fixing pin. The abutting portion is formed on the soldering portion or the fixing pin by blanking, and presses against the circuit board.

In one embodiment, the contact portion is bent and extends from an end of the elastic portion, and both the width of the contact portion and the width of the base are greater than the width of the elastic portion.

In one embodiment, a front end of the contact portion has two guide chamfers, the lengths of the two guide chamfers are different, and a contact tip is formed between the two guide chamfers.

In one embodiment, a side wall of the insulating body has at least one slot for receiving a part of the abutting portion, the length of the slot being greater than the height of the abutting portion.

In one embodiment, the soldering portion and the abutting portion are both formed by blanking, and the abutting portion extends laterally downwards from the soldering portion by a length that is smaller than a length by which the soldering portion extends downwards.

In one embodiment, a groove is formed between the soldering portion and the abutting portion.

As compared with the related art, among other things, the present invention has the following beneficial effects.

The electrical connector belongs to one of electrical connector series of different height specifications. The terminal has the soldering portion. The shielding case has the fixing pin. The fixing pin and/or the soldering portion are formed by blanking. The insulating bodies, the terminals and the shielding cases of a plurality of electrical connectors are the same, except that blanking shapes of the soldering portions and/or the fixing pins are different. Therefore, a series of the electrical connectors of different height specifications can share the same insulating body, and the terminals and the shielding cases of different height specifications can be manufactured by simply adjusting the blanking die of the soldering portion or the fixing pin, so that the electrical connectors can meet different specification requirements. Also, the cost is lowered and the manufacture process is simple.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a schematic three-dimensional exploded view of an electrical connector according to one embodiment of the present invention.

FIG. 2 is a schematic three-dimensional exploded view of the electrical connector of FIG. 1 from another angle of view.

FIG. 3 is a schematic three-dimensional view of terminals installed in an insulating body according to one embodiment of the present invention.

FIG. 4 is a schematic three-dimensional assembled view of the electrical connector according to one embodiment of the present invention.

FIG. 5 is a schematic top view of the electrical connector according to one embodiment of the present invention.

FIG. 6 is a schematic side view of the electrical connector according to one embodiment of the present invention.

FIG. 7 is a schematic side view of an electrical connector of a second height specification according to one embodiment of the present invention.

FIG. 8 is a schematic side view of an electrical connector of a third height specification according to one embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

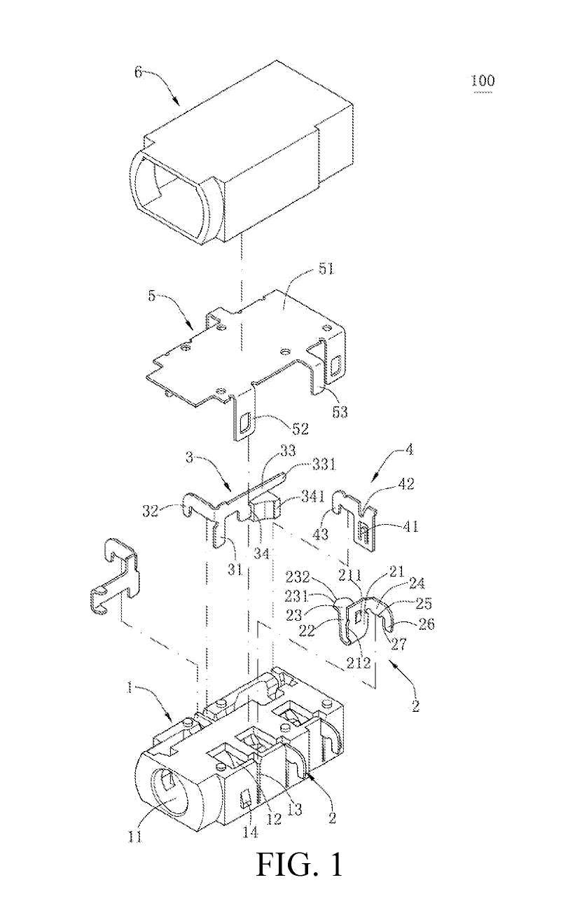

As shown in FIG. 1, an electrical connector 100 according to one embodiment of the present invention belongs to one of electrical connector series of different height specifications. The electrical connector 100 includes an insulating body 1, a plurality of terminals disposed in the insulating body 1, a shielding case 5 covering the insulating body 1, and a waterproof sleeve 6 sleeved over the insulating body 1.

Referring to FIG. 1, the insulating body 1 has a circular insertion hole 11. The insertion hole 11 is recessed backwards from a front end of the insulating body 1 and is formed through the insulating body 1. A plurality of receiving slots 12 for receiving the terminals is provided on two sides of the insertion hole 11. The receiving slot 12 is in communication with the insertion hole 11. The receiving slot 12 is recessed downwards from a top end of the insulating body 1 and is not formed through a bottom surface of the insulating body 1. A side wall of the insulating body 1 is provided with a plurality of slots 13. A top end of each of the receiving slots 12 is in communication with a corresponding slot 13. The slot 13 is recessed downwards from a top surface of the insulating body 1 by a length that is approximately equal to the height of the insulating body 1, but is not formed through the insulating body 1. The side wall of the insulating body 1 is further provided with a plurality of protruding blocks 14.

As shown in FIG. 1, the terminals include four signal terminals 2 and a pair of switch terminals. The switch terminals include a movable terminal 3 and a stationary terminal 4.

Referring now to FIG. 1 to FIG. 3, the signal terminal 2 has an upright base 21 fixed in the receiving slot 12. A reverse buckle 211 protrudes from a plate surface of the base 21. A plurality of barbs 212 is provided on two side surfaces of the base 21. The signal terminal 2 is stably positioned in the receiving slot 12 by the reverse buckle 211 and the barbs 212. An elastic portion 22 extends from one end of the base 21, and the elastic portion 22 and the base 21 are in a same plane or approximately parallel to each other. At least one contact portion 23 protruding from an end of the elastic portion 22 extends into the insertion hole 11, and both the width of the contact portion 23 and the width of the base 21 are greater than the width of the elastic portion 22. The contact portion 23 has two guide chamfers 231, the lengths of the two guide chamfers 231 are different and a contact tip 232 is formed between the guide chamfers 231. In this embodiment, the elastic portion 22 is bent upwards from a bottom end of the base 21. The end of the elastic portion 22 is provided with the contact portion 23, and the contact portion 23 is located above a middle portion of the base 21, so that the elastic portion 22 extends a great length and has good elasticity. A top side edge of the base 21 is bent and extends to form a connecting portion 24. The connecting portion 24 is perpendicular to the base 21 and extends outwards through the side wall of the insulating body 1. The connecting portion 24 extends downwards to form an abutting portion 25 and a soldering portion 26. The length by which the abutting portion 25 extends downwards is smaller than the length by which the soldering portion 26 extends downwards. The abutting portion 25 is partially received in the slot 13 and restricted by the slot 13, but is not fixed in the slot 13. The length of the slot 13 is greater than the height of the abutting portion 25. The connecting portion 24, the abutting portion 25 and the soldering portion 26 are in a same plane and are in the shape of a plate and formed by blanking. During manufacturing of the terminals, the base 21 and the elastic portion 22 may remain unchanged, and the height of the terminal can be adjusted by simply changing the blanking shape of the soldering portion 26, thereby adapting to the electrical connectors 100 of different height specifications. A groove 27 is formed between the soldering portion 26 and the abutting portion 25. When the soldering portion 26 is soldered to a circuit board 200, the abutting portion 25 presses against the circuit board 200, and the groove 27 may receive a solder material (not shown) flowing from the soldering portion 26 to prevent wicking.

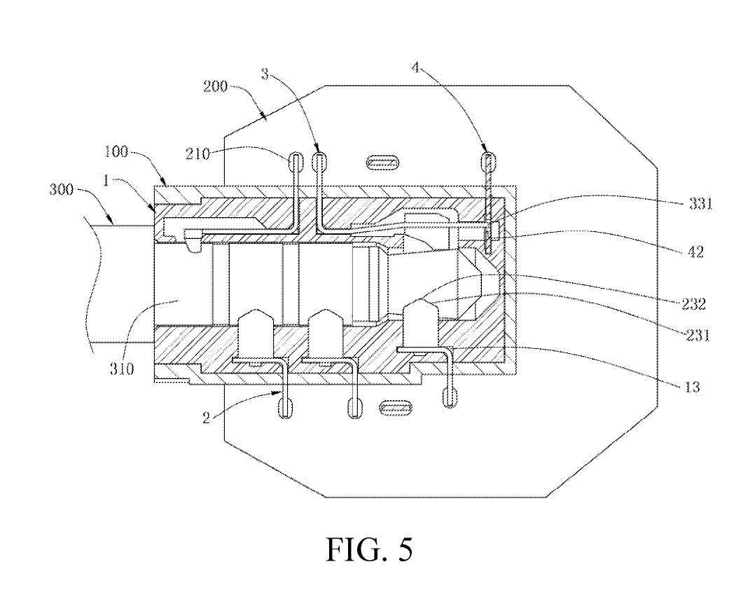

As shown in FIG. 1 and FIG. 5, the switch terminals include a movable terminal 3 and a stationary terminal 4 that are disposed opposite to each other. The movable terminal 3 has a first fixing portion 31 fixed in the receiving slot 12, and a first soldering portion 32 bent and extending from a side edge of a front end of the first fixing portion 31. The first soldering portion 32 is formed by blanking and in the shape of a plate. One side of the first soldering portion 32 is also provided with a plurality of abutting portions 25. The first fixing portion 31 extends backwards and is branched into a first elastic arm 33 and a second elastic arm 34. The first elastic arm 33 is located above and parallel to the second elastic arm 34. An end of the first elastic arm 33 has a first contact portion 331. The second elastic arm 34 has an insulating block 341. A distance between the first contact portion 331 and the first fixing portion 31 is greater than a distance between the insulating block 341 and the first fixing portion 31. When the insulating block 341 is pushed, the second elastic arm 34 drives the first elastic arm 33 to displace, where the distance by which the first contact portion 331 displaces is greater than the distance by which the insulating block 341 displaces, so that the movement of the movable terminal 3 is sensitive. In other embodiments, the insulating block 341 may be provided on the first elastic arm 33, and the first contact portion 331 may be located on the second elastic arm 34, as long as it can be ensured that the distance between the first contact portion 331 and the first fixing portion 31 is greater than the distance between the insulating block 341 and the first fixing portion 31.

As shown in FIGS. 1, 2 and 5, the stationary terminal 4 is in the shape of a plate, disposed at a rear end of the movable terminal 3, and has a second fixing portion 41. A second contact portion 42 is disposed above the second fixing portion 41 and may be maintained in contact with or separated from the first contact portion 331. A second soldering portion 43 is bent laterally and extending downwards from the second fixing portion 41 and extending through the side wall of the insulating body 1. The abutting portion 25 is also provided between the second soldering portion 43 and the second fixing portion 41.

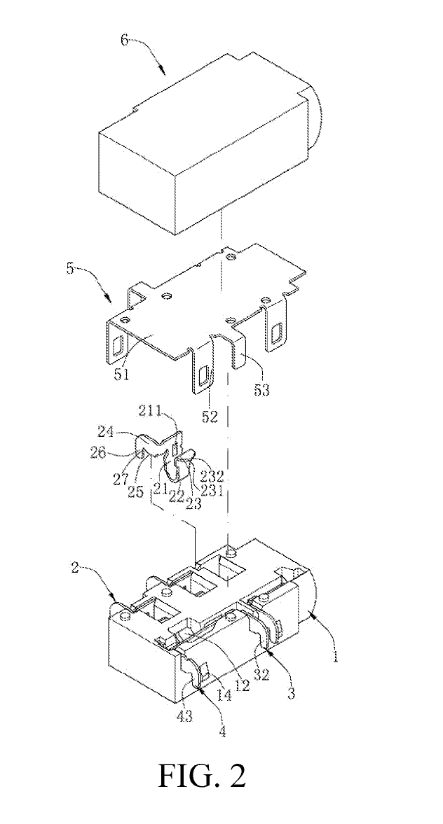

As shown in FIGS. 2-4, the shielding case 5 has a flat plate portion 51 covering the top surface of the insulating body 1 to shield the terminals. A plurality of buckling portions 52 and a plurality of fixing pins 53 extend downwards from two sides of the flat plate portion 51. The buckling portions 52 are buckled to the protruding blocks 14 on the side wall of the insulating body 1, and the fixing pins 53 are soldered to the circuit board 200. In this embodiment, the soldering portion 26 of the terminal is formed by blanking, and the fixing pin 53 is bent and extends from the flat plate portion 51. In other embodiments, the fixing pin 53 may be formed by blanking, and provided with the abutting portion 25 pressing against the circuit board 200, so as to control the height difference between the electrical connector 100 and the circuit board 200. Alternatively, the soldering portion 26 and the fixing pin 53 may both be formed by blanking, and are each provided with the abutting portion 25 pressing against the circuit board 200.

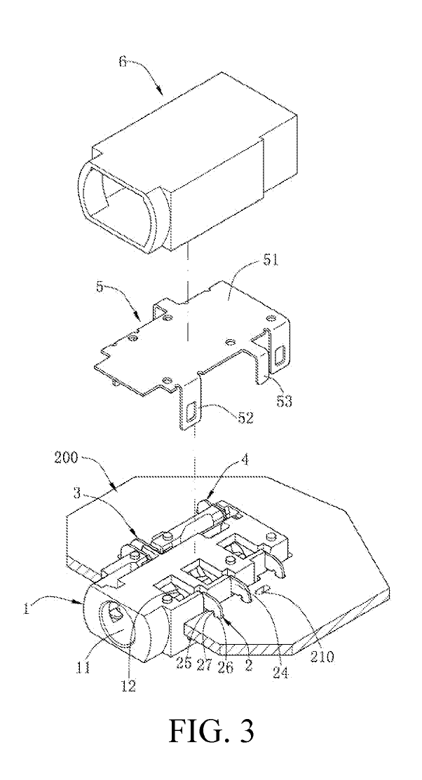

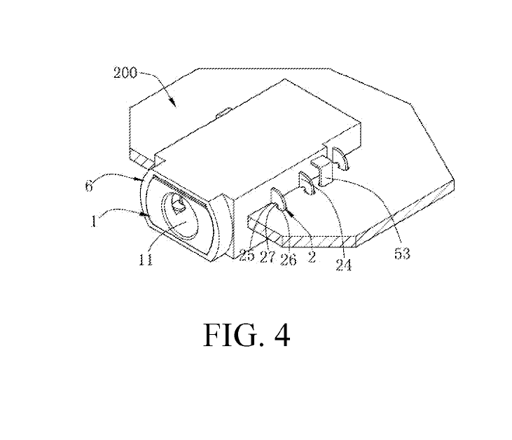

As shown in FIGS. 3 and 4, the waterproof sleeve 6 is disposed around the insulating body 1, and most preferably, integrally wraps outer peripheries of the insulating body 1 and the shielding case 5, in such a manner that only an opening end of the insertion hole 11 is not wrapped by the waterproof sleeve 6. The waterproof sleeve 6 disposed at the outer periphery of the insulating body 1 prevents water from flowing from the insertion hole 11 to the circuit board 200 to affect electrical connection.

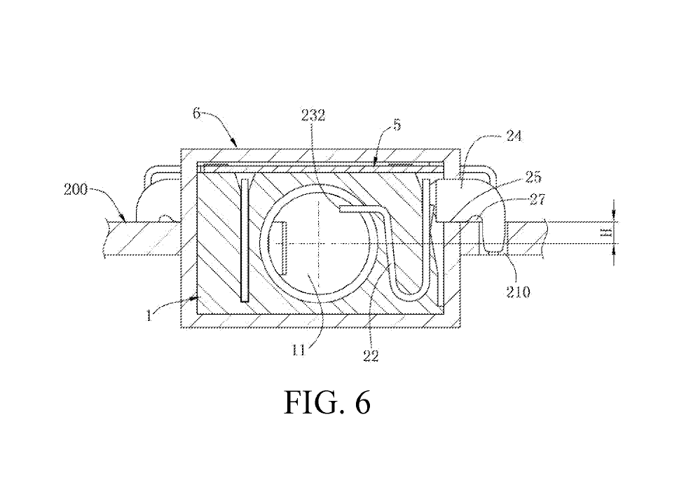

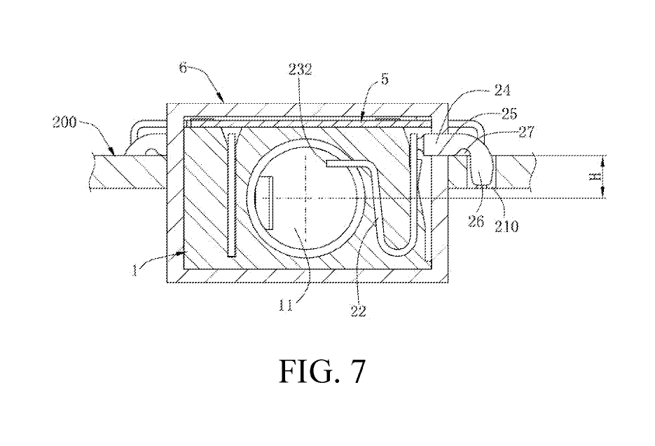

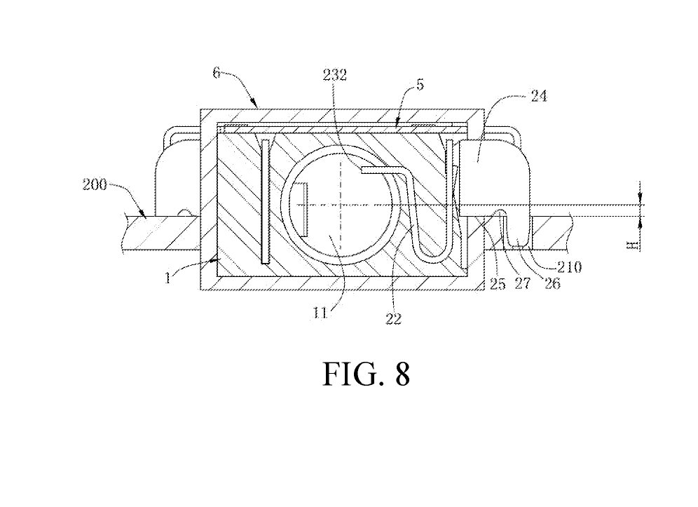

As shown in FIGS. 4 and 6-8, the electrical connector 100 is soldered to the circuit board 200 in a sinking manner. The circuit board 200 is provided with a plurality of through holes 210 for inserting the soldering portion 26 and the fixing pins 53. Meanwhile, the abutting portion 25 presses against a surface of the circuit board 200, and by adjusting the height of the abutting portion 25, a distance H between the center of circle of the insertion hole 11 and the circuit board 200 can be changed as the height of the abutting portion 25 changes. In this way, the electrical connectors 100 of different height specifications can be manufactured. In addition, since the soldering portion 26 and/or the fixing pin 53 are formed by blanking, the blanking shape of the soldering portion 26 and/or the fixing pin 53 can be changed by simply changing the blanking die of the soldering portion 26 and/or the fixing pin 53 during manufacturing of the terminal and/or the shielding case 5 by using a continuous die method, so as to manufacture the terminals and/or the shielding cases 5 of different height specifications, adapting to electrical connector series of different height specifications. The manufacturing process is simple and the cost is lowered.

As shown in FIG. 5, the electrical connector 100 is used for mating an audio plug 300. The audio plug 300 has a plurality of metal segments 310 for correspondingly contacting the signal terminals 2. In an initial state, the first contact portion 331 of the movable terminal 3 is maintained in contact with the second contact portion 42 of the stationary terminal 4, and the switch terminal is maintained in a normally closed state. Alternatively, the position of the second contact portion 42 may also be changed as required, so that the switch terminal is maintained normally open in the initial state. When the audio plug 300 is inserted into the insertion hole 11, the audio plug 300 pushes the insulating block 341, drives the second elastic arm 34 to move, and then drives the first elastic arm 33 to move, so that the first contact portion 331 moves away from the second contact portion 42, and the switch terminal is cut off, thereby achieving an on/off effect. When the audio plug 300 is inserted into the insertion hole 11, the audio plug 300 pushes the contact portion 23 of the signal terminal 2, and the contact tip 232 scratches the metal segments 310, which ensures effective contact between the audio plug 300 and the signal terminal 2. Moreover, when the audio plug 300 pushes the signal terminal 2, a side surface of the elastic portion 22 urges against an inner wall of the receiving slot 12, to prevent the terminal from deformation such as skewing when being pushed.

Based on the above, the present invention, among other things, has the following beneficial effects.

(1) The soldering portion 26 and the fixing pin 53 are inserted into the circuit board 200, the abutting portion 25 presses against the surface of the circuit board 200. By adjusting the height of the abutting portion 25, the distance H between the center of circle of the insertion hole 11 and the circuit board 200 can be changed as the height of the abutting portion 25 changes. In this way, the electrical connectors 100 of different height specifications can be manufactured.

(2) The soldering portion 26 and/or the fixing pin 53 is formed by blanking, the blanking shape of the soldering portion 26 and/or the fixing pin 53 can be changed by simply changing the blanking die of the soldering portion 26 and/or the fixing pin 53 during manufacturing of the terminal and/or the shielding case 5 by using a continuous die method, so as to manufacture the terminals and/or the shielding cases 5 of different height specifications, adapting to electrical connector series of different height specifications. The manufacturing process is simple and the cost is lowered.

(3) When the audio plug 300 pushes the signal terminal 2, the side surface of the elastic portion 22 urges against the inner wall of the receiving slot 12, to prevent the terminal from deformation such as skewing when being pushed.

(4) The abutting portion 25 is formed on the soldering portion 26 or the fixing pin 53 by blanking, which simplifies the manufacturing process. Further, the groove 27 is formed between the soldering portion 26 and the abutting portion 25. When the soldering portion 26 is soldered to the circuit board 200, the abutting portion 25 presses against the circuit board 200, and the groove 27 may receive a solder material (not shown) flowing from the soldering portion 26 to prevent wicking.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. An electrical connector, belonging to one of electrical connector series of different height specifications, used for being fixed to a circuit board, and comprising:
an insulating body;
a plurality of terminals, each having a base fixed in the insulating body, an elastic portion bent and extending from one end of the base, a contact portion protruding from the elastic portion, and a soldering portion bent and extending from a side edge of the other end of the base;
a shielding case, disposed on the insulating body, and having at least one fixing pin; and
an abutting portion, formed on the soldering portion or the fixing pin by blanking,
wherein the abutting portion presses against the circuit board, and a height difference between the insulating body and the circuit board is adjustable by adjusting the height of the abutting portion.

2. The electrical connector according to claim 1, wherein a side wall of the insulating body comprises at least one slot for receiving a part of the abutting portion, and the length of the slot is greater than the height of the abutting portion.

3. The electrical connector according to claim 1, wherein the soldering portion and the abutting portion are both formed by blanking, and the abutting portion extends laterally downwards from the soldering portion by a length that is smaller than a length by which the soldering portion extends downwards.

4. The electrical connector according to claim 3, wherein a groove is formed between the soldering portion and the abutting portion.

5. The electrical connector according to claim 1, wherein the insulating body comprises a plurality of receiving slots, the terminals are disposed in the receiving slots, and when the contact portion is pressed, a side surface of the elastic portion urges against an inner wall of the receiving slot.

6. The electrical connector according to claim 1, wherein the soldering portion is bent and extends from a top side edge of the base, and the soldering portion is perpendicular to the base.

7. The electrical connector according to claim 1, wherein the contact portion is bent and extends from an end of the elastic portion, and the width of the contact portion is greater than the width of the elastic portion.

8. The electrical connector according to claim 1, wherein a front end of the contact portion has two guide chamfers, and a contact tip is formed between the two guide chamfers.

9. The electrical connector according to claim 1, wherein the elastic portion is bent and extends upwards from a lower edge of the base, the elastic portion is parallel to the base, an end of the elastic portion is bent and extends to form the contact portion, and the contact portion is located above a middle portion of the base.

10. The electrical connector according to claim 1, wherein an insertion hole is formed in the center of the insulating body, the abutting portion presses against the circuit board at a different height, and a height difference between the center of circle of the insertion hole and the circuit board is also different.

11. The electrical connector according to claim 1, wherein the abutting portion and the fixing pin are both formed by blanking, and when the fixing pin is inserted into the circuit board, the abutting portion presses against a surface of the circuit board.

12. The electrical connector according to claim 1, wherein the terminals are formed by continuous die stamping, the soldering portion is formed by blanking in a blanking die, and the height of the abutting portion is adjusted by replacing a different blanking die.

13. An electrical connector series, comprising:
a plurality of electrical connectors of different height specifications, each of the electrical connectors comprising:
an insulating body;
a plurality of terminals, disposed in the insulating body, and each having a base fixed in the insulating body, an elastic portion bent and extending from one end of the base, a contact portion provided on the elastic portion, and a soldering portion bent and extending from a side edge of the other end of the base; and
a shielding case, covering the insulating body, two sides of the shielding case being provided with at least one fixing pin, and the fixing pin and/or the soldering portion being formed by blanking,
wherein the insulating body, the terminals and the shielding case of each electrical connector are the same as those in other electrical connectors, except that blanking shapes of the soldering portions and/or the fixing pins are different.

14. The electrical connector series according to claim 13, wherein the electrical connector is mounted on a circuit board, the soldering portion and/or the fixing pin is provided thereon with an abutting portion, the abutting portion presses against the circuit board, and when the soldering portion and/or the fixing pin is formed by blanking, the blanking shapes of the soldering portion and/or the fixing pin can be changed so as to change the height of the abutting portion.

15. The electrical connector series according to claim 14, wherein an insertion hole is formed in the center of the insulating body, and when the height of the abutting portion is different, a height difference between the insertion hole and the circuit board is also different.

16. The electrical connector series according to claim 14, wherein a groove is formed between the soldering portion and the abutting portion.

17. The electrical connector series according to claim 13, wherein a side wall of the insulating body comprises at least one slot for receiving a part of the abutting portion, the length of the slot being greater than the height of the soldering portion.

18. The electrical connector series according to claim 17, wherein the elastic portion is bent and extends upwards from a lower edge of the base, the elastic portion is parallel to the base, an end of the elastic portion is bent and extends to form the contact portion, and the contact portion is located above a middle portion of the base.

19. The electrical connector series according to claim 13, wherein the soldering portion is bent and extends from a top side edge of the base, and the soldering portion is perpendicular to the base.

20. The electrical connector series according to claim 13, wherein the insulating body comprises a plurality of receiving slots, the terminals are disposed in the receiving slots, and when the contact portion is pressed, a side surface of the elastic portion urges against an inner wall of the receiving slot.

21. The electrical connector series according to claim 13, wherein the terminals are formed by continuous die stamping, the soldering portion is formed by blanking in a blanking die, and the shape of the soldering portion is adjusted by replacing a different blanking die.

22. An electrical connector for being fixed to a circuit board, comprising:
an insulating body;
a plurality of terminals, each having a base fixed in the insulating body, an elastic portion bent and extending from one end of the base, a contact portion protruding from the elastic portion, and a soldering portion bent and extending from a side edge of the other end of the base;
a shielding case, disposed on the insulating body, and having at least one fixing pin; and
an abutting portion, formed on the soldering portion or the fixing pin by blanking, and presses against the circuit board.

23. The electrical connector according to claim 22, wherein the contact portion is bent and extends from an end of the elastic portion, and both the width of the contact portion and the width of the base are greater than the width of the elastic portion.

24. The electrical connector according to claim 22, wherein a front end of the contact portion has two guide chamfers, the lengths of the two guide chamfers are different, and a contact tip is formed between the two guide chamfers.

25. The electrical connector according to claim 22, wherein a side wall of the insulating body comprises at least one slot for receiving a part of the abutting portion, the length of the slot being greater than the height of the abutting portion.

26. The electrical connector according to claim 22, wherein the soldering portion and the abutting portion are both formed by blanking, and the abutting portion extends laterally downwards from the soldering portion by a length that is smaller than a length by which the soldering portion extends downwards.

27. The electrical connector according to claim 26, wherein a groove is formed between the soldering portion and the abutting portion.
